(19) United States
(12) Patent Application Publication
(10) Pub. No.: US 2020/0082318 A1
(43) Pub. Date: Mar. 12, 2020

(54) METHOD AND DEVICE FOR DETERMINING DELIVERY REGION

(71) Applicants: Beijing Jingdong Shangke Information Technology Co., Ltd., Beijing (CN); Beijing Jingdong Century Trading Co.,Ltd., Beijing (CN)

(72) Inventors: Xu LIU, Beijing (CN); Boyang LIU, Beijing (CN); Ke ZHAO, Beijing (CN); Yang YANG, Beijing (CN); Feng ZHANG, Beijing (CN)

(21) Appl. No.: 16/498,279

(22) PCT Filed: Mar. 23, 2018
(86) PCT No.: PCT/CN2018/080198

§ 371 Date: Sep. 26, 2019

(30) Foreign Application Priority Data
May 19, 2017 (CN) 201710356899.4

(51) Int. Cl. G06Q 10/06; G06Q 10/08; H04W 4/029

(52) U.S. Cl. CPC G06Q 10/06315; H04W 4/029; G06Q 10/0838

(57) ABSTRACT

Provided are a method and device for determining a delivery region. The method comprises: acquiring, within a specified historical period, information of respective geographical locations to which goods have been properly delivered in a specified geographical region (201); mapping, to a grid-based map, the information of the respective geographical locations to which goods have been properly delivered to obtain a mapped map (202); determining, for each grid cell, a distance between said grid cell and a grid cell closest thereto in a geographical location to which goods have been properly delivered (203); performing clustering on grid cells having distances within a preset value range to obtain multiple delivery region units (204); and performing clustering on the multiple delivery region units to obtain at least one delivery region comprising the multiple delivery region units (205). The present solution improves efficiency of allocating delivery regions.

### CROSS-REFERENCE TO RELATED APPLICATIONS

This application claims priority to Chinese Patent Application No. 201710356899.4, filed on May 19, 2017 by the applicants Beijing Jindong Century Trading Co., Ltd. and Beijing Jingdong Shangke Information Technology Co., Ltd., and entitled “Method and Apparatus for Determining Delivery Region”, the content of which is incorporated by reference in its entirety.

### TECHNICAL FIELD

The present disclosure relates to the field of computer technology, specifically to the field of Internet technology, and more specifically to a method and apparatus for determining a delivery region.

### BACKGROUND

With the rapid growth of e-commerce, the express delivery business has also developed rapidly. Before a courier delivers articles, a delivery site needs to divide delivery locations into delivery regions.

However, the existing method for dividing delivery regions, which is mainly based on experience, is low in division efficiency and susceptible to subjective factors.

### SUMMARY

An objective of the present disclosure is to provide an improved method and apparatus for determining a delivery region to solve the technical problems mentioned in the Background part.

In a first aspect, the embodiments of the present disclosure provide a method for determining a delivery region, including: acquiring information of each delivered geographical location in a designated geographical region within a designated historical time period; mapping the information of each delivered geographical location to a grid-based map to obtain a mapped map; determining, for each grid, a distance between the grid and a grid of a nearest delivered geographical location; clustering the grids at the distances within a preset value range to obtain a plurality of delivery region units; and clustering the plurality of delivery region units to obtain at least one delivery region including the plurality of delivery region units.

In some embodiments, before obtaining a plurality of delivery region units, the method further includes: dividing, based on Voronoi diagrams, the mapped map using the grid of each delivered geographical location as a point in each Voronoi diagram to obtain a plurality of sub geographical regions; for each class of geographical region obtained by grid clustering, if the class of geographical region includes at least two sub geographical regions, merging the at least two sub geographical regions; and determining the merged geographical regions and the non-merged sub geographical regions as the plurality of delivery region units.

In some embodiments, the at least one delivery region is a plurality of delivery regions; and after clustering the plurality of delivery region units to obtain at least one delivery region, the method further includes: adjusting, based on a delivery quantity in each delivery region unit within the designated historical time period, the delivery region units included in each of the plurality of delivery regions; or adjusting, based on a delivery duration in each delivery region unit within the designated historical time period, the delivery region units included in each of the plurality of delivery regions.

In some embodiments, the adjusting, based on a delivery quantity in each delivery region unit within the designated historical time period, the delivery region units included in each of the plurality of delivery regions includes: determining, for each of the at least one delivery region, a delivery quantity of the delivery region within the designated historical time period, where the delivery quantity of the delivery region is the sum of delivery quantities of the delivery region units; dividing, in response to determining that the delivery quantity of the delivery region is greater than a preset quantity range, one or more delivery region units in the delivery region into other delivery region; dividing, in response to determining that the delivery quantity of the delivery region is smaller than the preset quantity range, one or more delivery region units in other delivery region into the delivery region.

In some embodiments, the adjusting, based on a delivery duration in each delivery region unit within the designated historical time period, the delivery region units included in each of the plurality of delivery regions includes: determining, for each of the at least one delivery region, a delivery duration of the delivery region within the designated historical time period, where the delivery duration of the delivery region is the sum of delivery durations of the delivery region units; dividing, in response to determining that the delivery duration of the delivery region is greater than a preset duration range, one or more delivery region units in the delivery region into other delivery region; dividing, in response to determining that the delivery duration of the delivery region is smaller than the preset duration range, one or more delivery region units in other delivery region into the delivery region.

In a second aspect, the present disclosure provides an apparatus for determining a delivery region, including: an acquisition unit, configured to acquire information of each delivered geographical location in a designated geographical region within a designated historical time period; a mapping unit, configured to map the information of each delivered geographical location to a grid-based map to obtain a mapped map; a determination unit, configured to determine, for each grid, a distance between the grid and a grid of a nearest delivered geographical location; a clustering unit, configured to cluster the grids at the distances within a preset value range to obtain a plurality of delivery region units; and a region determination unit, configured to cluster the plurality of delivery region units to obtain at least one delivery region including the plurality of delivery region units.

In some embodiments, the apparatus further includes: a sub geographical region determination unit configured to divide, based on Voronoi diagrams, the mapped map using the grid of each delivered geographical location as a point in each Voronoi diagram to obtain a plurality of sub geographical regions; a merging unit configured to merge, for each class of geographical region obtained by grid clustering, if the class of geographical region induces at least two sub geographical regions, the at least two sub geographical regions; and a region unit determination unit configured to determine the merged geographical regions and the non-merged sub geographical regions as the plurality of delivery region units.

In some embodiments, the at least one delivery region is a plurality of delivery regions; and the apparatus further includes: a first adjustment unit configured to adjust, based on a delivery quantity in each delivery region unit within the designated historical time period, the delivery region units included in each of the plurality of delivery regions; or a second adjustment unit configured to adjust, based on a delivery duration in each delivery region unit within the designated historical time period, the delivery region units included in each of the plurality of delivery regions.

In some embodiments, the first adjustment unit includes: a first determination module configured to determine, for each of the at least one delivery region, a delivery quantity of the delivery region within the designated historical time period, where the delivery quantity of the delivery region is the sum of delivery quantities of the delivery region units; a first division module configured to divide, in response to determining that the delivery quantity of the delivery region is greater than a preset quantity range, one or more delivery region units in the delivery region into other delivery region; a first region division module configured to divide, in response to determining that the delivery quantity of the delivery region is smaller than the preset quantity range, one or more delivery region units in other delivery region into the delivery region.

In some embodiments, the second adjustment unit includes: a second determination module configured to determine, for each of the at least one delivery region, a delivery duration of the delivery region within the designated historical time period, where the delivery duration of the delivery region is the sum of delivery durations of the delivery region units; a second division module configured to divide, in response to determining that the delivery duration of the delivery region is greater than a preset duration range, one or more delivery region units in the delivery region into other delivery region; a second region division module configured to divide, in response to determining that the delivery duration of the delivery region is smaller than the preset duration range, one or more delivery region units in other delivery region into the delivery region.

According to the method and apparatus for determining a delivery region provided by the embodiments of the present disclosure, information of each delivered geographical location in a designated geographical region within a designated historical time period is acquired. The information of each delivered geographical location is mapped to a grid-based map to obtain a mapped map. Then, for each grid, a distance between the grid and a grid of a nearest delivered geographical location is determined. The grids at the distances within a preset value range are clustered to obtain a plurality of delivery region units. Finally, the plurality of delivery region units are clustered to obtain at least one delivery region including the plurality of delivery region units. Thus, the efficiency of allocating delivery regions is improved.

### BRIEF DESCRIPTION OF THE DRAWINGS

After reading detailed descriptions of non-limiting embodiments with reference to the following accompanying drawings, other features, objectives and advantages of the present disclosure will become more apparent.

FIG. 1 is a diagram of an exemplary system architecture in which the present disclosure may be implemented;

FIG. 2 is a flowchart of an embodiment of a method for determining a delivery region according to the present disclosure;

FIG. 3a and FIG. 3b are schematic diagrams showing distance determination by grids in the method for determining a delivery region according to the present disclosure;

FIG. 4 is a schematic diagram of an application scenario of the method for determining a delivery region according to the present disclosure;

FIG. 5 is a flowchart of another embodiment of a method for determining a delivery region according to the present disclosure;

FIG. 6 is a flowchart of another embodiment of a method for determining a delivery region according to the present disclosure;

FIG. 7 is a flowchart of another embodiment of a method for determining a delivery region according to the present disclosure;

FIG. 8 is a flowchart of another embodiment of a method for determining a delivery region according to the present disclosure;

FIG. 9 is a schematic structural diagram of an embodiment of an apparatus for determining a delivery region according to the present disclosure; and

FIG. 10 is a schematic structural diagram of a computer system adapted to implement a server of the embodiments of the present disclosure.

### DETAILED DESCRIPTION OF EMBODIMENTS

The present disclosure will be further described below in detail in combination with the accompanying drawings and the embodiments. It may be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should be noted that the embodiments in the present disclosure and features in the embodiments may be combined with each other without conflicts. The present disclosure will be described in detail with reference to the accompanying drawings and embodiments.

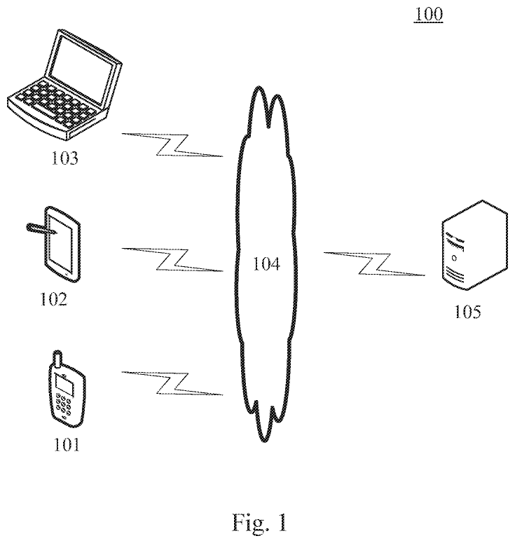

FIG. 1 shows an exemplary system architecture 100 in which a method for determining a delivery region or an apparatus for determining a delivery region according to embodiments of the present disclosure may be implemented.

As shown in FIG. 1, the system architecture 100 may include terminal devices 101, 102 and 103, a network 104, and a server 105. The network 104 serves as a medium providing a communication link between the terminal devices 101, 102 and 103 and the server 105. The network 104 may include various connection types, such as wired or wireless communication links, or optical fibers.

A user may interact with the server 105 by using the terminal device 101, 102 or 103 through the network 104 to receive or send messages, etc. Various communication client applications, such as web browser applications, shopping applications, search applications, instant messaging tools, mailbox clients and social platform software, may be installed on the terminal devices 101, 102 and 103.

The terminal devices 101, 102 and 103 may be various electronic devices having display screens and supporting to receive information related to delivery regions, including but not limited to a smart phone, a tablet computer, an e-book reader, an MP3 (Moving Picture Experts Group Audio Layer III) player, an MP4 (Moving Picture Experts Group Audio Layer IV) player, a laptop computer, a desktop computer, etc.

The server 105 may be a server for providing various services, for example, a backend server providing a support for displaying delivery regions on the terminals 101, 102 and 103. The backend server may performing processing such as analyzing the received data such as delivered geographical location information, and feed back the processing result (e.g., data related to delivery regions) to a terminal device.

It should be noted that the method for determining a delivery region, provided by the embodiments of the present disclosure, is generally executed by the server 105. Accordingly, the apparatus for determining a delivery region is generally provided in the server 105.

It should be appreciated that the numbers of the terminal devices, the network and the server in FIG. 1 are merely illustrative. Any number of terminal devices, networks and servers may be provided based on actual requirements.

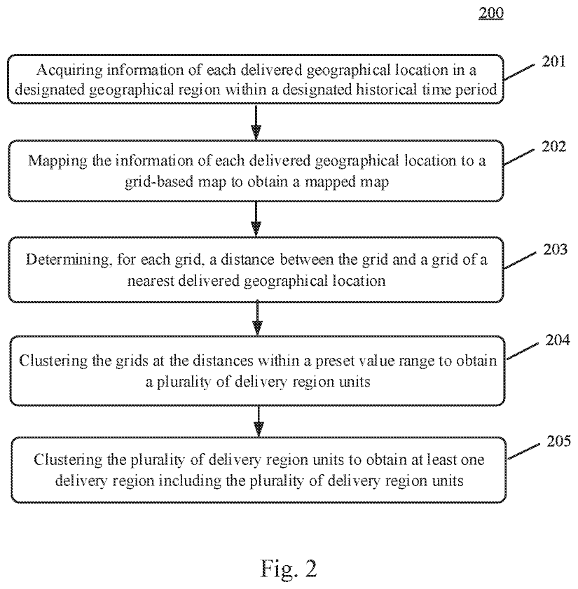

Further referring to FIG. 2, a process 200 of an embodiment of the method for determining a delivery region according to the present disclosure is shown. The method for determining a delivery region includes the following steps.

Step 201, information of each delivered geographical location in a designated geographical region within a designated historical time period is acquired.

In this embodiment, an electronic device (e.g., the server shown in FIG. 1) on which the method for determining a delivery region is performed may acquire information of a plurality of delivered geographical locations in a designated geographical region within a designated historical time period. The designated historical time period is a designated elapsed time period, e.g., yesterday or yesterday morning. Taking the duration of the time period as a delivery cycle, a courier may perform a round of deliveries to a responsible region at each delivery cycle. The designated geographical region is an artificially defined geographical region. The delivered geographical location information is information of a geographical location where the courier delivers articles, and the geographical location is within the designated geographical region. Generally, the delivered geographical location information includes longitude information and latitude information. After delivery, the courier generally uploads the delivered geographical location information at the delivered location. This embodiment determines delivery region units by using the delivered geographical location information.

Step 202, the information of each delivered geographical location is mapped to a grid-based map to obtain a mapped map.

In this embodiment, the electronic device maps the delivered geographical location information to a map, which is a grid-based map. The mapping in this embodiment is to present location points corresponding to the longitude information and latitude information included in the delivered geographical location information in a map. Grid-based processing may be performed on a map to obtain a grid-based map. After the delivered geographical location information is mapped to the map, the corresponding point of each delivered geographical location on the mapped map falls into a grid. The grid-based processing on a map is to divide the map into a plurality of grids. For example, a 1 square meter of geographical region may be regarded as a grid of a grid-based map.

It should be noted that the step of mapping the delivered geographical location information to a map may be performed first, and then the step of grid-based processing on the map is performed to obtain a mapped map.

Step 203, for each grid, a distance between the grid and a grid of a nearest delivered geographical location is determined.

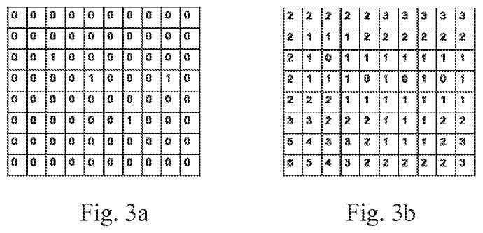

In this embodiment, for each grid, the electronic device determines a distance between the grid and a grid of a nearest delivered geographical location. To determine a distance between grids, a calculation rule for the distance between the grids is first determined. A first rule may be used to infer the distance based on relative positions of the grids. For example, if a grid represents 1 (m²), it may be determined that the distance between each grid and an adjacent grid is 1 (m). If two grids are separated by a grid, the distance between the two grids is 2 (m). A second rule may also be used to calculate the distance between a designated location in one grid and the same designated location in another grid, for example, to calculate the distance between the centers of two grids. The distance between a grid of the delivered geographical location and the grid itself is 0. As shown in FIG. 3, FIG. 3a shows a mapped map, where “1” indicates grids of delivered geographical locations, and “0” indicates grids of other geographical locations except the delivered geographical locations. FIG. 3b shows distances between each grid and grids of nearest delivered geographical locations after distance calculation, where the “0” indicates grids of delivered geographical locations, and any number in other grids indicates a distance between the grid where the number is located and a grid of a nearest delivered geographical location.

Step 204, the grids at the distances within a preset value range are clustered to obtain a plurality of delivery region units.

In this embodiment, based on the distances determined in step 203, the electronic device clusters the grids at the distances within a preset value range. Then, the geographical regions composed of a plurality of grids obtained after the clustering are used as delivery region units. The delivery region units are geographical regions composed of a plurality of grids, and are units constituting delivery regions. A delivery region unit may be a building or an alley. The preset value range is a range of values preset for distances, and the grids at the distances within the range from the grid of the delivered geographical location can participate in the clustering. The clustering here is based on the distances, and the electronic device clusters the grids that are within the preset value range and are close to each other.

For example, the preset value range is less than or equal to 5 (m). A grid of a delivered geographical location a and a plurality of adjacent grids are clustered into a class a, where the distances between the plurality of adjacent grids and the delivered geographical location a are 1 to 5. Some grids are adjacent to the outermost grids of the class a, and the distances between these grids and the grid of the delivered geographical location a are more than 5, which does not meet the preset value range. In addition, the distances between these grids and the grid of any delivered geographical location are more than 5. Various classes of grids may be separated by these grids at large distances from the grid of each delivered geographical location. Generally, the regions corresponding to these grids may be wide streets or rivers, etc.

Step 205, the plurality of delivery region units are clustered to obtain at least one delivery region including the plurality of delivery region units.

In this embodiment, after obtaining a plurality of delivery region units, the electronic device clusters the plurality of delivery region units to obtain at least one delivery region including the plurality of delivery region units. Each delivery region includes a plurality of delivery region units. After a delivery region is obtained, the delivery region may be used as a delivery region for a courier.

Specifically, a plurality of clustering algorithms may be used, including unsupervised clustering, such as a K-means algorithm, a Gaussian mixture model (GMM) algorithm, or a combination of the two.

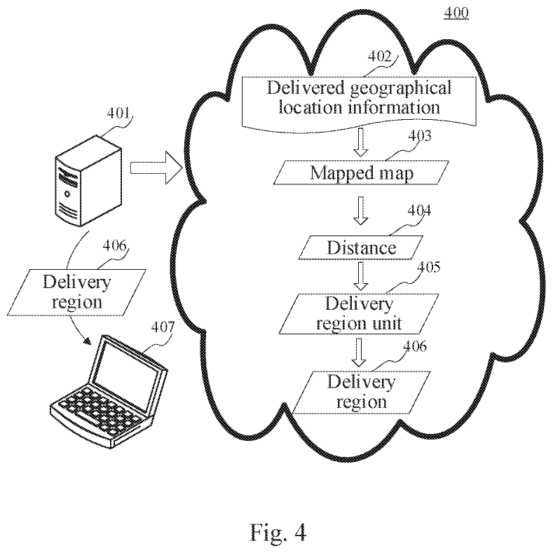

Further referring to FIG. 4, a schematic diagram of an application scenario of the method for determining a delivery region according to this embodiment is shown. In the application scenario of FIG. 4, a server 401 first acquires delivered geographical location information 402 of each delivered geographical location in Beijing Xihongmen district at 8:00 to 12:00 yesterday. The server then maps the acquired delivered geographical location information 402 to a grid-based map to obtain a mapped map 403, where the distance between the grid of each delivered geographical location and an adjacent grid is set to 1. The server then determines, for each grid, a distance 404 between the grid and the grid of a nearest delivered geographical location. Based on respective determined distances, the grids at the distances of less than 5 are clustered to obtain a plurality of delivery region units 405. Finally, the plurality of delivery region units 405 are clustered to obtain at least one delivery region 406, and the obtained at least one delivery region 406 is sent to a terminal device 407, as shown in FIG. 4.

The above embodiment of the present disclosure speeds up the allocation of regions by using grids, and improves the accuracy of allocation by two times of clustering. By using the method in the embodiment, the allocation efficiency of delivery regions can be improved, and the problem that the allocation is affected by subjective factors can be solved.

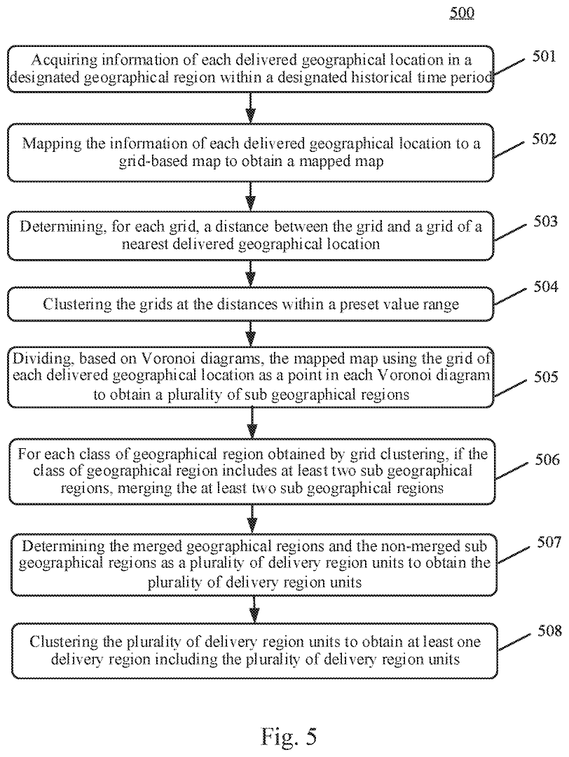

Further referring to FIG. 5, a process 500 of another embodiment of the method for determining a delivery region is shown. The process 500 of the method for determining a delivery region includes the following steps.

Step 501, information of each delivered geographical location in a designated geographical region within a designated historical time period is acquired.

In this embodiment, a server may acquire information of a plurality of delivered geographical locations in a designated geographical region within a designated historical time period. The designated historical time period is a designated elapsed time period, e.g., yesterday or yesterday morning. Taking the duration of the time period as a delivery cycle, a courier may perform a round of deliveries to a responsible region at each cycle. The designated geographical region is a defined geographical region. The delivered geographical location information is generally geographical location information uploaded by a courier at a delivered location after delivery. This embodiment determines delivery region units by using the delivered geographical location information.

Step 502, the information of each delivered geographical location is mapped to a grid-based map to obtain a mapped map.

In this embodiment, the server maps the delivered geographical location information to a map, which is a grid-based map. Grid-based processing may be performed on a map to obtain a grid-based map. After the delivered geographical location information is mapped to the map, the corresponding point of each delivered geographical location on the mapped map falls into a grid. The grid-based processing on a map is to divide the map into a plurality of grids. For example, a 1 square meter of geographical region may be regarded as a grid of a grid-based map.

It should be noted that the step of mapping the delivered geographical location information to a map may be performed first, and then the step of grid-based processing on the map is performed to obtain a mapped map.

Step 503, for each grid, a distance between the grid and a grid of a nearest delivered geographical location is determined.

In this embodiment, for each grid, the server determines a distance between the grid and a grid where a corresponding point of a nearest delivered geographical location on the mapped map is located. To determine a distance between grids, a calculation rule for the distance between the grids is first determined. If a grid represents 1 (m²), it may be determined that the distance between each grid and an adjacent grid is 1 (m). If two grids are separated by a grid, the distance between the two grids is 2 (m). The distance between a designated location in one grid and the same designated location in another grid may also be calculated, for example, the distance between the centers of two grids is calculated. The distance between a grid of the delivered geographical location and the grid itself is 0.

The distance may be obtained by distance transform. Specifically, the distance may be obtained by the following formula:

$${D}_{f} ( p ) = {min}_{q = {G}^{′}} ( d ( p , q ) + f ( p ) )$$

Here, G′ is a grid-based map that has been mapped with the delivered geographical location information. D_{f}(p) is a distance between each grid and a grid of a delivered geographical location nearest to the grid, p is any grid, and q is a grid of a delivered geographical location. d(p,q) is a distance function, indicating the distance from any grid p to the grid q of the nearest delivered geographical location. The distance function here may be selected from a variety of distance functions, e.g., Euclidean distance, or Manhattan distance, etc. f(p) is also a variable, and the specific value of f(p) is as follows:

$$f ( p ) = \{ \begin{matrix}0 \\ ∞\end{matrix}$$

When p is in a street or on a common road, f(p)=0. When p is in a river or on a highway, f(p)=∞.

Step 504, the grids at the distances within a preset value range are clustered.

In this embodiment, based on the obtained distances, the server clusters the grids at the distances within a preset value range. The preset value range is a range of values preset for distances, and the grids at the distances within the range from the grid of the delivered geographical location can participate in the clustering. The clustering here is based on the distances, and the server clusters the grids that are within the preset value range and are close to each other.

Step 505, based on Voronoi diagrams, the mapped map is divided using the grid of each delivered geographical location as a point in each Voronoi diagram to obtain a plurality of sub geographical regions.

In this embodiment, the server may divide a mapped map using the grid of each delivered geographical location as a point in each Voronoi diagram, where the points are for constituting the Voronoi diagrams. To draw Voronoi diagrams on the map, the grids of a plurality of delivered geographical locations first need to be connected into triangles, and then the perpendicular bisector of each side of the triangles is drawn to obtain a plurality of Voronoi diagrams surrounding the grids of the delivered geographical locations. The Voronoi diagrams are used as sub geographical regions.

It should be noted that, besides the Voronoi diagrams for dividing the mapped map, Delaunay triangulation may also be used for division, or the two division methods may be combined to obtain a plurality of sub geographical regions.

Step 506, for each class of geographical region obtained by grid clustering, if the class of geographical region includes at least two sub geographical regions, the at least two sub geographical regions are merged.

In this embodiment, various classes of geographical regions are obtained after clustering, and the server further processes the divided sub geographical regions based on the clustering results. For each class of geographical region, if the class of geographical region includes at least two sub geographical regions obtained by division, the at least two sub geographical regions are merged. The original at least two sub geographical regions are merged into one region.

Step 507, the merged geographical regions and the non-merged sub geographical regions are determined as a plurality of delivery region units.

In this embodiment, the server determines the merged geographical regions and the non-merged sub geographical regions as a plurality of delivery region units. In this way, a plurality of delivery region units are obtained by clustering and division.

Step 508, the plurality of delivery region units are clustered to obtain at least one delivery region including the plurality of delivery region units.

In this embodiment, after obtaining a plurality of delivery region units, the server clusters the plurality of delivery region units to obtain at least one delivery region including the plurality of delivery region units. Each delivery region includes a plurality of delivery region units. After a delivery region is obtained, the delivery region may be used as a delivery region for a courier.

In this embodiment, the division of the mapped map based on Voronoi diagrams may involve regions far from the delivered geographical locations, thereby reducing the probability of missing delivery regions.

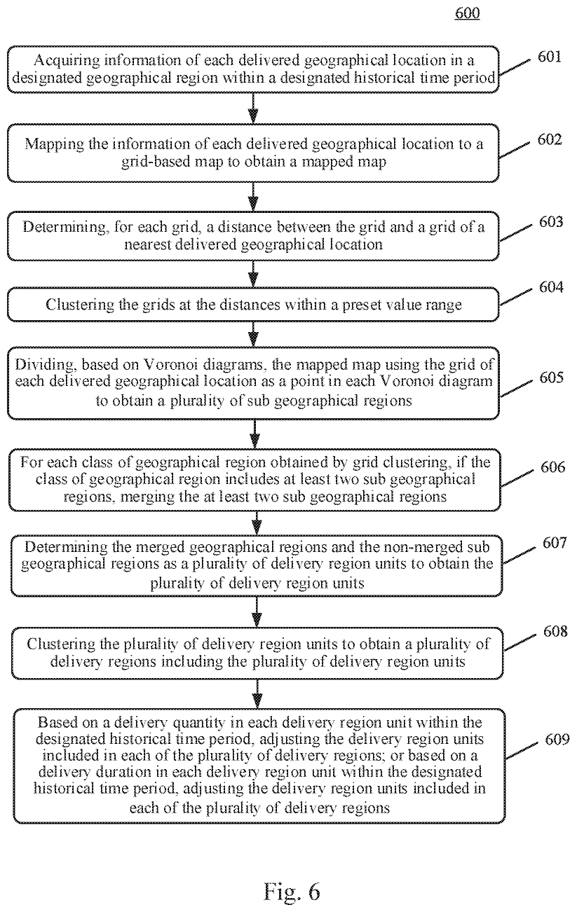

Further referring to FIG. 6, a process 600 of another embodiment of the method for determining a delivery region is shown. The process 600 of the method for determining a delivery region includes the following steps.

Step 601, information of each delivered geographical location in a designated geographical region within a designated historical time period is acquired.

In this embodiment, a server may acquire information of a plurality of delivered geographical locations in a designated geographical region within a designated historical time period. The designated historical time period is a designated elapsed time period, e.g., yesterday or yesterday morning. Taking the duration of the time period as a delivery cycle, a courier may perform a round of deliveries to a responsible region at each cycle. The designated geographical region is a defined geographical region. The delivered geographical location information is generally geographical location information uploaded by a courier at a delivered location after delivery. This embodiment determines delivery region units by using the delivered geographical location information.

Step 602, the information of each delivered geographical location is mapped to a grid-based map to obtain a mapped map.

In this embodiment, the server maps the delivered geographical location information to a map, which is a grid-based map. Grid-based processing may be performed on a map to obtain a grid-based map. After the delivered geographical location information is mapped to the map, each delivered geographical location falls into a grid. The grid-based processing on a map is to divide the map into a plurality of grids. For example, a 1 square meter of geographical region may be regarded as a grid of a grid-based map.

It should be noted that the step of mapping the delivered geographical location information to a map may be performed first, and then the step of grid-based processing on the map is performed to obtain a mapped map.

Step 603, for each grid, a distance between the grid and a grid of a nearest delivered geographical location is determined.

In this embodiment, for each grid, the server determines a distance between the grid and a grid of a nearest delivered geographical location. To determine a distance between grids, a calculation rule for the distance between the grids is first determined. If a grid represents 1 (m²), it may be determined that the distance between each grid and an adjacent grid is 1 (m). If two grids are separated by a grid, the distance between the two grids is 2 (m). The distance between a designated location in one grid and the same designated location in another grid may also be calculated, for example, the distance between the centers of two grids is calculated. The distance between a grid of the delivered geographical location and the grid itself is 0.

Step 604, the grids at the distances within a preset value range are clustered to obtain a plurality of delivery region units.

In this embodiment, based on the obtained distances, the server clusters the grids at the distances within a preset value range. Then, the geographical regions composed of a plurality of grids obtained after the clustering are used as delivery region units. The delivery region units are geographical regions composed of a plurality of grids, and are units constituting delivery regions. A delivery region unit may be a building or an alley. The preset value range is a range of values preset for distances, and the grids at the distances within the range from the grid of the delivered geographical location can participate in the clustering. The clustering here is based on the distances, and the server clusters the grids that are within the preset value range and are close to each other.

Step 605, the plurality of delivery region units are clustered to obtain a plurality of delivery regions including the plurality of delivery region units.

In this embodiment, after obtaining a plurality of delivery region units, the server clusters the plurality of delivery region units to obtain a plurality of delivery regions including the plurality of delivery region units. Each delivery region includes a plurality of delivery region units. After a delivery region is obtained, the delivery region may be used as a delivery region for a courier.

Step 606, the delivery region units included in each of the plurality of delivery regions are adjusted based on a delivery quantity in each delivery region unit within the designated historical time period; or the delivery region units included in each of the plurality of delivery regions are adjusted based on a delivery duration in each delivery region unit within the designated historical time period.

In this embodiment, the delivery quantity here refers to the quantity of articles delivered and signed by a courier, and the delivery duration refers to a duration that the courier delivers and signs articles. The designated historical time period may be a time period m which the server receives the delivered geographical location information. The server adjusts the delivery region units included in the delivery region based on the delivery quantity of each delivery region unit in the delivery region. For example, if the delivery quantity of each delivery region unit is too large (more than a preset quantity), the quantity of the delivery region unit in the delivery region is reduced. Vice versa, that is, if the delivery quantity of each delivery region unit is too small (smaller than a preset quantity), the quantity of the delivery region unit in the delivery region is increased.

The delivery region units may also be adjusted based on the delivery duration in each delivery region unit. For example, if the delivery duration of each delivery region unit is too long (more than a preset duration), the quantity of the delivery region unit in the delivery region is reduced. Vice versa, that is, if the delivery duration of each delivery region unit is too short (shorter than a preset duration), the quantity of the delivery region unit in the delivery region is increased.

In this embodiment, the delivery region units of the delivery region may be adjusted based on the delivery quantity or delivery duration of the delivery region, thereby further optimizing the delivery region based on actual situations.

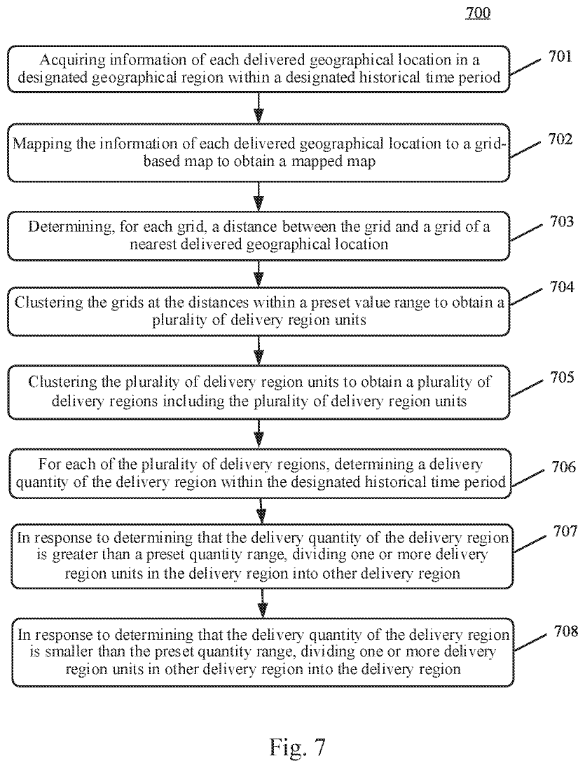

Further referring to FIG. 7, a process 700 of another embodiment of the method for determining a delivery region is shown. The process 700 of the method for determining a delivery region includes the following steps.

Step 701, information of each delivered geographical location in a designated geographical region within a designated historical time period is acquired.

In this embodiment, a server may acquire information of a plurality of delivered geographical locations in a designated geographical region within a designated historical time period. The designated historical time period is a designated elapsed time period, e.g., yesterday or yesterday morning. Taking the duration of the time period as a delivery cycle, a courier may perform a round of deliveries to a responsible region at each cycle. The designated geographical region is a defined geographical region. The delivered geographical location information is generally geographical location information uploaded by a courier at a delivered location after delivery. This embodiment determines delivery region units by using the delivered geographical location information.

Step 702, the information of each delivered geographical location is mapped to a grid-based map to obtain a mapped map.

In this embodiment, the server maps the delivered geographical location information to a map, which is a grid-based map. Grid-based processing may be performed on a map to obtain a grid-based map. After the delivered geographical location information is mapped to the map, the corresponding point of each delivered geographical location on the mapped map falls into a grid. The grid-based processing on a map is to divide the map into a plurality of grids. For example, a 1 square meter of geographical region may be regarded as a grid of a grid-based map.

It should be noted that the step of mapping the delivered geographical location information to a map may be performed first, and then the step of grid-based processing on the map is performed to obtain a mapped map.

Step 703, for each grid, a distance between the grid and a grid of a nearest delivered geographical location is determined.

In this embodiment, for each grid, the server determines a distance between the grid and a grid of a nearest delivered geographical location. To determine a distance between grids, a calculation rule for the distance between the grids is first determined. If a grid represents 1 (m²), it may be determined that the distance between each grid and an adjacent grid is 1 (m). If two grids are separated by a grid, the distance between the two grids is 2 (m). The distance between a designated location in one grid and the same designated location in another grid may also be calculated, for example, the distance between the centers of two grids is calculated. The distance between a grid of the delivered geographical location and the grid itself is 0.

Step 704, the grids at the distances within a preset value range are clustered to obtain a plurality of delivery region units.

In this embodiment, based on the obtained distances, the server dusters the grids at the distances within a preset value range. Then, the geographical regions composed of a plurality of grids obtained after the clustering are used as delivery region units. The delivery region units are geographical regions composed of a plurality of grids, and are units constituting delivery regions. A delivery region unit may be a building or an alley. The preset value range is a range of values preset for distances, and the grids at the distances within the range from the grid of the delivered geographical location can participate in the clustering. The clustering here is based on the distances, and the server clusters the grids that are within the preset value range and are close to each other.

Step 705, the plurality of delivery region units are clustered to obtain a plurality of delivery regions including the plurality of delivery region units.

In this embodiment, after obtaining a plurality of delivery region units, the server clusters the plurality of delivery region units to obtain a plurality of delivery regions including the plurality of delivery region units. Each delivery region includes a plurality of delivery region units. After a delivery region is obtained, the delivery region may be used as a delivery region for a courier.

Step 706, for each of the plurality of delivery regions, a delivery quantity of the delivery region within the designated historical time period is determined.

In this embodiment, for each delivery region, the server determines a delivery quantity of the delivery region within the designated historical time period. The designated historical time period here may be the same as the aforementioned designated historical time period. The delivery quantity of the delivery region is determined based on a delivery quantity of each delivery region unit in the delivery region. Specifically, the delivery quantity of the delivery region is the sum of the delivery quantities of the delivery region units in the delivery region. The delivery quantity of each delivery region unit may be obtained by determining the quantity of delivered geographical locations within the delivery region unit.

Step 707, in response to determining that the delivery quantity of the delivery region is greater than a preset quantity range, one or more delivery region units in the delivery region are divided into other delivery region.

In this embodiment, the preset quantity range is a range preset for delivery quantity. If the delivery quantity is not within the preset quantity range, the server adjusts the delivery region units in the delivery region. If determining that the delivery quantity of the delivery region is greater than the preset quantity range, the server makes a response: dividing one or more delivery region units in the delivery region into other delivery region. For example, the delivery region units at the edge of the delivery region are divided into adjacent delivery regions to reduce the delivery quantity of the delivery region.

Step 708, in response to determining that the delivery quantity of the delivery region is smaller than the preset quantity range, one or more delivery region units in other delivery region are divided into the delivery region.

In this embodiment, if determining that the delivery quantity of the delivery region is smaller than the preset quantity range, the server makes a response: dividing one or more delivery region units in other delivery region into the delivery region. Thus, a too small delivery quantity in the delivery region can be increased. For example, two delivery region units in an adjacent delivery region are divided into the delivery region.

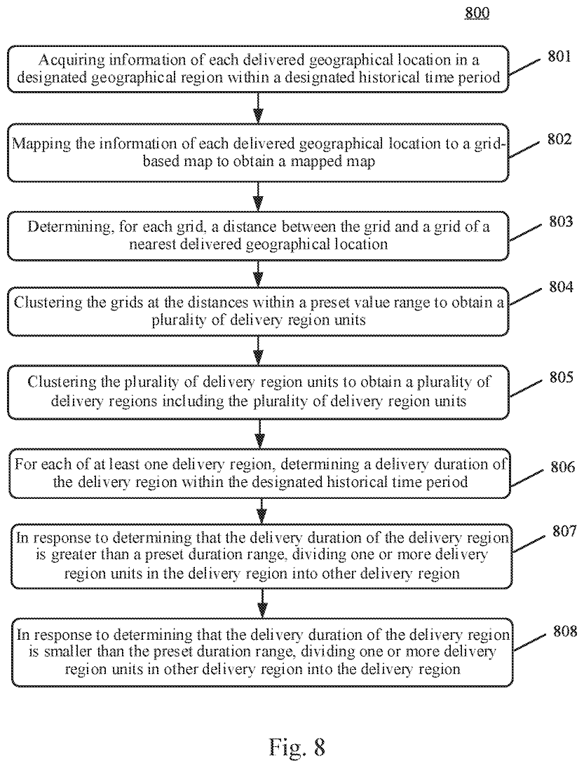

Further referring to FIG. 8, a process 800 of another embodiment of the method for determining a delivery region is shown. The process 800 of the method for determining a delivery region includes the following steps.

Step 801, information of each delivered geographical location in a designated geographical region within a designated historical time period is acquired.

In this embodiment, a server may acquire information of a plurality of delivered geographical locations in a designated geographical region within a designated historical time period. The designated historical time period is a designated elapsed time period, e.g., yesterday or yesterday morning. Taking the duration of the time period as a delivery cycle, a courier may perform a round of deliveries to a responsible region at each cycle. The designated geographical region is a defined geographical region. The delivered geographical location information is generally geographical location information uploaded by a courier at a delivered location after delivery. This embodiment determines delivery region units by using the delivered geographical location information.

Step 802, the information of each delivered geographical location is mapped to a grid-based map to obtain a mapped map.

In this embodiment, the server maps the delivered geographical location information to a map, which is a grid-based map. Grid-based processing may be performed on a map to obtain a grid-based map. After the delivered geographical location information is mapped to the map, the corresponding point of each delivered geographical location on the mapped map falls into a grid. The grid-based processing on a map is to divide the map into a plurality of grids. For example, a 1 square meter of geographical region may be regarded as a grid of a grid-based map.

It should be noted that the step of mapping the delivered geographical location information to a map may be performed first, and then the step of grid-based processing on the map is performed to obtain a mapped map.

Step 803, for each grid, a distance between the grid and a grid of a nearest delivered geographical location is determined.

In this embodiment, for each grid, the server determines a distance between the grid and a grid of a nearest delivered geographical location. To determine a distance between grids, a calculation rule for the distance between the grids is first determined. If a grid represents 1 (m²), it may be determined that the distance between each grid and an adjacent grid is 1 (m). If two grids are separated by a grid, the distance between the two grids is 2 (m). The distance between a designated location in one grid and the same designated location in another grid may also be calculated, for example, the distance between the centers of two grids is calculated. The distance between a grid of the delivered geographical location and the grid itself is 0.

Step 804, the grids at the distances within a preset value range are clustered to obtain a plurality of delivery region units.

In this embodiment, based on the obtained distances, the server clusters the grids at the distances within a preset value range. Then, the geographical regions composed of a plurality of grids obtained after the clustering are used as delivery region units. The delivery region units are geographical regions composed of a plurality of grids, and are units constituting delivery regions. A delivery region unit may be a building or an alley. The preset value range is a range of values preset for distances, and the grids at the distances within the range from the grid of the delivered geographical location can participate in the clustering. The clustering here is based on the distances, and the server clusters the grids that are within the preset value range and are close to each other.

Step 805, the plurality of delivery region units are clustered to obtain a plurality of delivery regions including the plurality of delivery region units.

In this embodiment, after obtaining a plurality of delivery region units, the server clusters the plurality of delivery region units to obtain a plurality of delivery regions including the plurality of delivery region units. Each delivery region includes a plurality of delivery region units. After a delivery region is obtained, the delivery region may be used as a delivery region for a courier.

Step 806, for each of at least one delivery region, a delivery duration of the delivery region within the designated historical time period is determined.

In this embodiment, for each delivery region, the server determines a delivery duration of the delivery region within the designated historical time period. The designated historical time period here may be the same as the aforementioned designated historical time period. The delivery duration of the delivery region is determined based on a delivery duration of each delivery region unit in the delivery region. Specifically, the delivery duration of the delivery region is the sum of the delivery durations of the delivery region units in the delivery region. The delivery duration of each delivery region unit may be determined by determining the time difference between the sent time (or received time) of the first delivered geographical location and the sent time (or received time) of the last delivered geographical location in the delivery region unit.

Step 807, in response to determining that the delivery duration of the delivery region is greater than a preset duration range, one or more delivery region units in the delivery region are divided into other delivery region.

In this embodiment, the preset duration range is a range preset for delivery duration. If the delivery duration is not within the preset duration range, the server adjusts the delivery region units in the delivery region. If determining that the delivery duration of the delivery region is greater than the preset duration range, the server makes a response: dividing one or more delivery region units in the delivery region into other delivery region. For example, the delivery region units at the edge of the delivery region are divided into adjacent delivery regions to shorten the delivery duration of the delivery region.

Step 808, in response to determining that the delivery duration of the delivery region is smaller than or equal to the preset duration range, one or more delivery region units in other delivery region are divided into the delivery region. [0127] in this embodiment, if determining that the delivery duration of the delivery region is smaller than the preset duration range, the server makes a response: dividing one or more delivery region units in other delivery region into the delivery region. Thus, a too short delivery duration in the delivery region can be increased. For example, two delivery region units in an adjacent delivery region are divided into the delivery region.

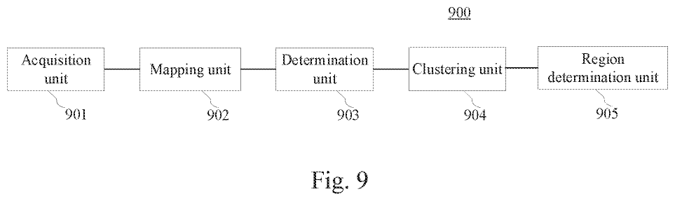

Further referring to FIG. 9, as an implementation of the above method shown in the figures, the present disclosure provides an embodiment of an apparatus for determining a delivery region, the embodiment of the apparatus corresponds to the embodiment of the method shown in FIG. 2, and the apparatus can be specifically applied to various types of electronic devices.

As shown in FIG. 9, the apparatus 900 for determining a delivery region according to this embodiment includes an acquisition unit 901, a mapping unit 902, a determination unit 903, a clustering unit 904, and a region determination unit 905. The acquisition unit 901 is configured to acquire information of each delivered geographical location in a designated geographical region within a designated historical time period; the mapping unit 902 is configured to map the information of each delivered geographical location to a grid-based map to obtain a mapped map; the determination unit 903 is configured to determine, for each grid, a distance between the grid and a grid of a nearest delivered geographical location; the clustering unit 904 is configured to cluster the grids at the distances within a preset value range to obtain a plurality of delivery region units; and the region determination unit 905 is configured to cluster the plurality of delivery region units to obtain at least one delivery region including the plurality of delivery region units.

In this embodiment, the acquisition unit 901 may acquire information of a plurality of delivered geographical locations in a designated geographical region within a designated historical time period. The designated historical time period is a designated elapsed time period, e.g., yesterday or yesterday morning. Taking the duration of the time period as a delivery cycle, a courier may perform a round of deliveries to a responsible region at each cycle. The designated geographical region is a defined geographical region. The delivered geographical location information is generally geographical location information uploaded by a courier at a delivered location after delivery. This embodiment determines delivery region units by using the delivered geographical location information.

In this embodiment, the mapping unit 902 maps the delivered geographical location information to a map, which is a grid-based map. Grid-based processing may be performed on a map to obtain a grid-based map. After the delivered geographical location information is mapped to the map, each delivered geographical location falls into a grid. The grid-based processing on a map is to divide the map into a plurality of grids. For example, a 1 square meter of geographical region may be regarded as a grid of a grid-based map.

In this embodiment, for each grid, the determination unit 903 determines a distance between the grid and a grid of a nearest delivered geographical location. To determine a distance between grids, a calculation rule for the distance between the grids is first determined. For example, if a grid represents 1 (m²), it may be determined that the distance between each grid and an adjacent grid is 1 (m). If two grids are separated by a grid, the distance between the two grids is 2 (m). The distance between a designated location in one grid and the same designated location in another grid may also be calculated, for example, the distance between the centers of two grids is calculated. The distance between a grid of the delivered geographical location and the grid itself is 0.

In this embodiment, the clustering unit 904 clusters the grids at the distances within a preset value range. Then, the geographical regions composed of a plurality of grids obtained after the clustering are used as delivery region units. The delivery region units are geographical regions composed of a plurality of grids, and are units constituting delivery regions. A delivery region unit may be a building or an alley. The preset value range is a range of values preset for distances, and the grids at the distances within the range from the grid of the delivered geographical location can participate in the clustering. The clustering here is based on the distances, and the clustering unit 904 clusters the grids that are within the preset value range and are close to each other.

In this embodiment, after obtaining a plurality of delivery region units, the region determination unit 905 clusters the plurality of delivery region units to obtain at least one delivery region including the plurality of delivery region units. Each delivery region includes a plurality of delivery region units. After a delivery region is obtained, the delivery region may be used as a delivery region for a courier.

In some optional implementations of this embodiment, the apparatus further includes: a sub geographical region determination unit (not shown) configured to divide, based on Voronoi diagrams, the mapped map using the grid of each delivered geographical location as a point in each Voronoi diagram to obtain a plurality of sub geographical regions; a merging unit (not shown) configured to merge, for each class of geographical region obtained by grid clustering, if the class of geographical region induces at least two sub geographical regions, the at least two sub geographical regions; and a region unit determination unit (not shown) configured to determine the merged geographical regions and the non-merged sub geographical regions as the plurality of delivery region units.

In some optional implementations of this embodiment, the at least one delivery region is a plurality of delivery regions; and the apparatus further includes: a first adjustment unit (not shown) configured to adjust, based on a delivery quantity in each delivery region unit within the designated historical time period, the delivery region units included in each of the plurality of delivery regions; or a second adjustment unit (not shown) configured to adjust, based on a delivery duration in each delivery region unit within the designated historical time period, the delivery region units included in each of the plurality of delivery regions.

In some optional implementations of this embodiment, the first adjustment unit includes: a first determination module (not shown) configured to determine, for each of the at least one delivery region, a delivery quantity of the delivery region within the designated historical time period, where the delivery quantity of the delivery region is the sum of delivery quantities of the delivery region units; a first division module (not shown) configured to divide, in response to determining that the delivery quantity of the delivery region is greater than a preset quantity range, one or more delivery region units in the delivery region into other delivery region; a first region division module (not shown) configured to divide, in response to determining that the delivery quantity of the delivery region is smaller than the preset quantity range, one or more delivery region units in other delivery region into the delivery region.

In some optional implementations of this embodiment, the second adjustment unit includes: a second determination module (not shown) configured to determine, for each of the at least one delivery region, a delivery duration of the delivery region within the designated historical time period, where the delivery duration of the delivery region is the sum of delivery durations of the delivery region units; a second division module (not shown) configured to divide, in response to determining that the delivery duration of the delivery region is greater than a preset duration range, one or more delivery region units in the delivery region into other delivery region; a second region division module (not shown) configured to divide, in response to determining that the delivery duration of the delivery region is smaller than the preset duration range, one or more delivery region units in other delivery region into the delivery region.

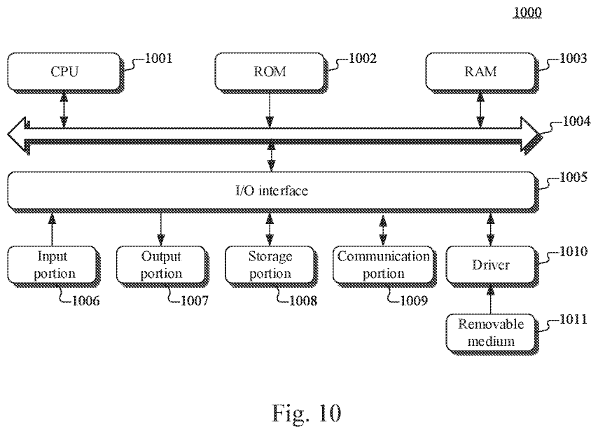

Hereinafter, referring to FIG. 10, a schematic structural diagram of a computer system 1000 adapted to implement an electronic device of the embodiments of the present disclosure is shown. The electronic device shown in FIG. 10 is merely an example, and should not limit the functions and scope of use of the embodiments of the present disclosure.

FIG. 10 shows a schematic structural diagram of a computer system adapted to implement an electronic device of the embodiments of the present disclosure. As shown in FIG. 10, the computer system 1000 includes a central processing unit (CPU) 1001, which can execute various appropriate actions and processes in accordance with a program stored in a read only memory (ROM) 1002 or a program loaded into a random access memory (RAM) 1003 from a storage portion 1008. The RAM 1003 also stores various programs and data required by operations of the system 1000. The CPU 1001, the ROM 1002 and the RAM 1003 are connected to each other through a bus 1004. An input/output (I/O) interface 1005 is also connected to the bus 1004.

The following parts are connected to the I/O interface 1005: an input portion 1006 including a keyboard, a mouse, etc.; an output portion 1007 including, a cathode ray tube (CRT), a liquid crystal display (LCD), a loudspeaker, etc.; a storage portion 1008 including a hard disk, etc.; and a communication portion 1009 including a network interface card, such as an LAN card or a modem. The communication portion 1009 executes communication processing through a network such as Internet. A driver 1010 is also connected to the I/O interface 1005 as needed. A removable medium 1011, such as a magnetic disk, an optical disk, a magneto-optical disk or a semiconductor memory, is installed on the driver 1010 as needed, so that a computer program read therefrom is installed in the storage portion 1008 as needed.

In particular, according to embodiments of the present disclosure, the process described above with reference to the flow chart may be implemented in a computer software program. For example, an embodiment of the present disclosure includes a computer program product, which comprises a computer program that is tangibly embedded in a computer readable medium. The computer program includes program codes for executing the method as illustrated in the flow chart. In such an embodiment, the computer program may be downloaded and installed from a network via the communication portion 1009, and/or may be installed from the removable medium 1011. The computer program, when executed by the central processing unit (CPU) 1001, implements the above functions as defined by the method of the present disclosure. It should be noted that the computer readable medium may be a computer readable signal medium or a computer readable storage medium or any combination of the above two. An example of the computer readable storage medium may include, but is not limited to: electric, magnetic, optical, electromagnetic, infrared, or semiconductor systems, apparatuses, elements, or a combination of any of the above. A more specific example of the computer readable storage medium may include, but is not limited to: electrical connection with one or more pieces of wire, a portable computer disk, a hard disk, a random access memory (RAM), a read only memory (ROM), an erasable programmable read only memory (EPROM or flash memory), an optical fiber, a portable compact disk read only memory (CD-ROM), an optical memory, a magnetic memory, or any suitable combination of the above. In the present disclosure, the computer readable storage medium may be any tangible medium containing or storing programs, which may be used by, or used in combination with, a command execution system, apparatus or element. In the present disclosure, the computer readable signal medium may include a data signal in the base band or propagating as a part of a carrier wave, in which computer readable program codes are carried. The propagating data signal may take various forms, including but not limited to an electromagnetic signal, an optical signal, or any suitable combination of the above. The computer readable signal medium may also be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium, including but not limited to: wireless, wired, optical cable, RF medium, etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logical functions. It should be further noted that, in some alternative implementations, the functions denoted by the blocks may occur in a sequence different from the sequences shown in the figures. For example, any two blocks presented in succession may be executed substantially in parallel, or they may sometimes be executed in a reverse sequence, depending on the functions involved. It should be further noted that each block in the block diagrams and/or flow charts as well as a combination of blocks in the block diagrams and/or flow charts may be implemented using a dedicated hardware-based system executing specified functions or operations, or by a combination of dedicated hardware and computer instructions.

The units involved in the embodiments of the present disclosure may be implemented by means of software or hardware. The described units may also be provided in a processor, for example, described as: a processor, including an acquisition unit 901, a mapping unit 902, a determination unit 903, a clustering unit 904, and a region determination unit 905. The names of these units do not do not constitute a limitation to such units themselves in some cases, for example, the receiving unit may be described as “a unit for acquiring information of each delivered geographical location in a designated geographical region within a designated historical time period.”

As another aspect, the present disclosure further provides a computer readable medium. The computer readable medium may be included in the apparatus described in the above embodiments, or a stand-alone computer readable medium without being assembled into the apparatus. The computer readable medium stores one or more programs, when the one or more programs are executed by the apparatus, causing the apparatus to: acquire information of each delivered geographical location in a designated geographical region within a designated historical time period; map the information of each delivered geographical location to a grid-based map to obtain a mapped map; determine, for each grid, a distance between the grid and a grid of a nearest delivered geographical location; cluster the grids at the distances within a preset value range to obtain a plurality of delivery region units; and cluster the plurality of delivery region units to obtain at least one delivery region including the plurality of delivery region units.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the present disclosure. Technical schemes formed by the above-described features being interchanged with, but not limited to, technical features with similar functions disclosed in the present disclosure are examples.

1. A method for determining a delivery region, comprising:
acquiring information of each delivered geographical location in a designated geographical region within a designated historical time period;
mapping the information of each delivered geographical location to a grid-based map to obtain a mapped map;
determining, for each grid, a distance between the grid and a grid of a nearest delivered geographical location;
clustering the grids at the distances within a preset value range to obtain a plurality of delivery region units; and
clustering the plurality of delivery region units to obtain at least one delivery region comprising the plurality of delivery region units.

2. The method for determining a delivery region according to claim 1, wherein before obtaining a plurality of delivery region units, the method further comprises:
dividing, based on Voronoi diagrams, the mapped map using the grid of each delivered geographical location as a point in etch Voronoi diagram to obtain a plurality of sub geographical regions;
for each class of geographical region obtained by grid clustering, if the class of geographical region comprises at least two sub geographical regions, merging the at least two sub geographical regions; and
determining the merged geographical regions and the non-merged sub geographical regions as the plurality of delivery region units.

3. The method for determining a delivery region according to claim 1, wherein the at least one delivery region is a plurality of delivery regions; and
after clustering the plurality of delivery region units to obtain at least one delivery region, the method further comprises:
adjusting, based on a delivery quantity in each delivery region unit within the designated historical time period, the delivery region units comprised in each of the plurality of delivery regions; or
adjusting, based on a delivery duration in each delivery region unit within the designated historical time period, the delivery region units comprised in each of the plurality of delivery regions.

4. The method for determining a delivery region according to claim 3,
wherein the adjusting, based on a delivery quantity in each delivery region unit within the designated historical time period, the delivery region units comprised in each of the plurality of delivery regions comprises:
determining, for each of the at least one delivery region, a delivery quantity of the delivery region within the designated historical time period, wherein the delivery quantity of the delivery region is the sum of delivery quantities of the delivery region units;
dividing, in response to determining that the delivery quantity of the delivery region is greater than a preset quantity range, one or more delivery region units in the delivery region into other delivery region;
dividing, in response to determining that the delivery quantity of the delivery region is smaller than the preset quantity range, one or more delivery region units in other delivery region into the delivery region.

5. The method for determining a delivery region according to claim 3, wherein the adjusting, based on a delivery duration in each delivery region unit within the designated historical time period, the delivery region units comprised in each of the plurality of delivery regions comprises:
determining, for each of the at least one delivery region, a delivery duration of the delivery region within the designated historical time period, wherein the delivery duration of the delivery region is the sum of delivery durations of the delivery region units;
dividing, in response to determining that the delivery duration of the delivery region is greater than a preset duration range, one or more delivery region units in the delivery region into other delivery region;
dividing, in response to determining that the delivery duration of the delivery region is smaller than the preset duration range, one or more delivery region units in other delivery region into the delivery region.

6. An apparatus for determining a delivery region, comprising:
at least one processor; and
a memory storing instructions, the instructions when executed by the at least one processor, cause the at least one processor to perform operations, the operations comprising:
acquiring information of each delivered geographical location in a designated geographical region within a designated historical time period;
mapping the information of each delivered geographical location to a grid-based map to obtain a mapped map;
determining, for each grid, a distance between the grid and a grid of a nearest delivered geographical location;
clustering the grids at the distances within a preset value range to obtain a plurality of delivery region units; and
clustering the plurality of delivery region units to obtain at least one delivery region comprising the plurality of delivery region units.

7. The apparatus for determining a delivery region according to claim 6, wherein before obtaining a plurality of delivery region units, the operations further comprise:
dividing, based on Voronoi diagrams, the mapped map using the grid of each delivered geographical location as a point in each Voronoi diagram to obtain a plurality of sub geographical regions;
merging, for each class of geographical region obtained by grid clustering, if the class of geographical region comprises at least two sub geographical regions, the at least two sub geographical regions; and
determining the merged geographical regions and the non-merged sub geographical regions as the plurality of delivery region units.

8. The apparatus for determining a delivery region according to claim 6, wherein the at least one delivery region is a plurality of delivery regions; and
after clustering the plurality of delivery region units to obtain at least one delivery region, the operations further comprise:
adjusting, based on a delivery quantity in each delivery region unit within the designated historical time period, the delivery region units comprised in each of the plurality of delivery regions; or
adjusting, based on a delivery duration in each delivery region unit within the designated historical time period, the delivery region units comprised in each of the plurality of delivery regions.

9. The apparatus for determining a delivery region according to claim 8, wherein the adjusting, based on a delivery quantity in each delivery region unit within the designated historical time period, the delivery region units comprised in each of the plurality of delivery regions comprises:
determining, for each of the at least one delivery region, a delivery quantity of the delivery region within the designated historical time period, wherein the delivery quantity of the delivery region is the sum of delivery quantities of the delivery region units;
dividing, in response to determining that the delivery quantity of the delivery region is greater than a preset quantity range, one or more delivery region units in the delivery region into other delivery region;
dividing, in response to determining that the delivery quantity of the delivery region is smaller than the preset quantity range, one or more delivers region units in other delivery region into the delivery region.

10. The apparatus for determining a delivery region according to claim 8, wherein the adjusting, based on a delivery duration in each delivery region unit within the designated historical time period, the delivery region units comprised in each of the plurality of delivery regions comprises:
determining, for each of the at least one delivery region, a delivery duration of the delivery region within the designated historical time period, wherein the delivery duration of the delivery region is the sum of delivery durations of live delivery region units;
dividing, in response to determining that the delivery duration of the delivery region is greater than a preset duration range, one or more delivery region units in the delivery region into other delivery region;
dividing, in response to determining that the delivery duration of the delivery region is smaller than the preset duration range, one or more delivery region units in other delivery region into the delivery region.

11. (canceled)

12. A non-transitory computer readable storage medium, storing a computer program thereon, wherein the computer program, when executed by a processor, causes the processor to perform operations, the operations comprising:
acquiring information of each delivered geographical location in a designated geographical region within a designated historical time period;
mapping the information of each delivered geographical location to a grid-based map to obtain a mapped map;
determining, for each grid, a distance between the grid and a grid of a nearest delivered geographical location;
clustering the grids at the distance within a preset value range to obtain a plurality of delivery region units; and
clustering the plurality of delivery region units to obtain at least one delivery region comprising the plurality of delivery region units.

13. The computer readable storage medium according to claim 12, wherein before obtaining a plurality of delivery region units, the operations further comprise:
dividing, based on Voronoi diagrams, the mapped map using the grid of each delivered geographical location as a point in each Voronoi diagram to obtain a plurality of sub geographical regions;
for each class of geographical region obtained by grid clustering, if the class of geographical region comprises at least two sub geographical regions, merging the at least two sub geographical regions; and
determining the merged geographical regions and the non-merged sub geographical regions as the plurality of delivery region units.

14. The computer readable storage medium according to claim 12, wherein the at least one delivery region is a plurality of delivery regions; and
after clustering the plurality of delivery region units to obtain at least one delivery region, the operations further comprise:
adjusting, based on a delivery quantity in each delivery region unit within the designated historical time period, the delivery region units comprised in each of the plurality of delivery regions; or
adjusting, based on a delivery duration in each delivery region unit within the designated historical lime period, the delivery region units comprised in each of the plurality of delivery regions.

15. The computer readable storage medium according to claim 14, wherein the adjusting, based on a delivery quantity in each delivery region unit within the designated historical time period, the delivery region units comprised in each of the plurality of delivery regions comprises:
determining, for each of the at least one delivery region, a delivery quantity of the delivery region within the designated historical time period, wherein the delivery quantity of the delivery region is the sum of delivery quantities of the delivery region units;
dividing, in response to determining that the delivery quantity of the delivery region is greater than a preset quantity range, one or mere delivery region units in the delivery region into other delivery region;
dividing, in response to determining that the delivery quantity of the delivery region is smaller than the preset quantity range, one or more delivery region units in other delivery region into the delivery region.

16. The computer readable storage medium according to claim 14, wherein the adjusting, based on a delivery duration in each delivery region unit within the designated historical time period, the delivery region units comprised in each of the plurality of delivery regions comprises:
determining, for each of the at least one delivery region, a delivery duration of the delivery region within the designated historical time period, wherein the delivery duration of the delivery region is the sum of delivery durations of the delivery region units;
dividing, in response to determining that the delivery duration of the delivery region is greater than a preset duration range, one or more delivery region units in the delivery region into other delivery region;
dividing, in response to determining that the delivery duration of the delivery region is smaller than the preset duration range, one or more delivery region units in other delivery region into the delivery region.
